(19) United States
(12) Patent Application Publication
(10) Pub. No.: US 2009/0293741 A1
(43) Pub. Date: Dec. 3, 2009

(54) SYSTEM, DEVICE AND METHOD FOR PROCESSING HARVESTED WALNUTS

(76) Inventors: Alan Reiff, Woodland, CA (US); Cory Pierce, Durham, CA (US); Allen Knowles, Magalia, CA (US)

Correspondence Address: HOLLAND LAW OFFICE P.L.L.C., P.O. BOX 1840, BOISE, ID, 83701-1840, US

(21) Appl. No.: 12/130,036

(22) Filed: May 30, 2008

(51) Int. Cl. A23N 5/00; B07B 9/00

(52) U.S. Cl. 99/570; 99/569; 426/482

(57) ABSTRACT

A system and method for processing harvested walnuts that includes a walnut separator for separating walnuts without hulls from walnuts with hulls prior to a hulling process in order to increase productivity of the huller. A huller by-pass system conveys walnuts without hulls to a post-hulling processing. A walnut separator may include a screen having a selected screen size that permit walnuts without hulls to pass through the screen and prohibit walnuts with hulls and therefore a larger diameter, to pass through the screen. Alternately the walnut separator may include an optical sensor positioned to scan harvested walnuts. A controller connected to the optical sensor processes input from the optical sensor and selectively actuates a walnut selection or ejection device causing a walnut to by-pass a process.

The present invention relates generally to devices and methods for processing harvested nuts and more particularly to a system and method for processing harvested walnuts that includes a device and step for separating walnuts without hulls from those with hulls prior to the step for removing hulls from walnuts.

### BACKGROUND

There are numerous devices, systems and methods that relate generally to the process of separating debris from harvested nuts and cracked nuts from un-cracked nuts and the meat of the nuts from their shells.

Devices have been developed that provide for the separation of harvested nuts from debris: U.S. Pat. Nos. 4,927,030, (sorting sticks, weeds and other debris from peanuts and sorts peanuts into size categories), 4,535,894, (separating peanuts from vines and debris), 4,364,222, (separating nuts from orchard trash in a windrow), 4,194,346, (separating fallen nuts from leaves and other foreign matter) and 2,762,506, (separating nuts from debris and other foreign matter).

There are devices and systems for cracking nuts and removing nuts from the shell: U.S. Pat. Nos. 5,404,809, (nut shelling device), 5,296,248, (cracking walnuts by subjecting the shell to opposed compressive forces) and 3,662,799, (cracking nuts, without crushing the kernels).

Similarly, there are devices and methods for separating partially cracked nuts from cracked nuts. U.S. Pat. Nos. 6,902,067, (removing debris including empty shells and sorting out unacceptable in-shell nuts), 6,824,804, (pecan processing method and system wherein pecan parts that fall beneath the cracker are conveyed to an air separation device that removes dust and shells for disposal), 6,527,124, (separating blank pistachio shells and other debris from pistachio nuts) and 5,879,734, (nuts and nut parts created in the cracker are separated in successive steps by width and thickness).

In addition there are various illustrations of the concept of combining various functions or steps in a system: U.S. Pat. Nos. 6,527,124, (combines a flotation tank, a weir and discharge channel, a conveyor within the flotation tank and a pair of counter-rotating rollers for squeezing floating items towards the weir and discharge channel) and 5,467,700, (a device for cleaning, shelling, and sizing nuts in a single step).

There are unique challenges presented by the processing of harvested walnuts that involve removal and handling of the hulls that surround the harvested nut. Typically, the harvested walnuts or “field run” contains leaves, rocks, dirt, sticks, walnuts and other matter. Some of the harvested walnuts have hulls, some do not. According to current practices because some harvested walnuts have hulls, all harvested walnuts are sent through a huller for processing. The time and therefore the cost associated with processing walnuts are affected by this fact.

Advantage may be found in providing a device for processing harvested walnuts that sorts walnuts with hulls from those that have no hulls and diverts those walnuts that have no hulls in a manner that circumvents the huller. Similarly, advantage may be found in providing a method for processing harvested walnuts that includes the step of sorting walnuts with hulls from those that have no hulls and diverting those walnuts that have no hulls in a manner that circumvents a hulling step.

Sorting harvested walnuts without hulls for bypass from those with hulls would increase the volume per hour that the hulling plant can produce while reducing wear/maintenance on the huller. Sorting harvested walnuts as described will also improve overall product quality by eliminating walnut damage that occurs within the huller to those walnuts that are selected for bypass.

One object of the present invention therefore is to provide a device for processing harvested walnuts that sorts walnuts with hulls from those that have no hulls and diverts those walnuts that have no hulls in a manner that circumvents the huller. Another object of the invention is to provide a method for processing harvested walnuts that includes the steps of sorting walnuts with hulls from those that have no hulls and diverting those walnuts that have no hulls in a manner that circumvents a hulling step.

### SUMMARY OF THE INVENTION

The present invention is directed to a system and method for processing harvested walnuts that includes a walnut separator for separating walnuts without hulls from walnuts with hulls prior to a hulling process in order to increase productivity of the huller. A huller by-pass system conveys walnuts without hulls to post-hulling processing. In a preferred embodiment of the invention, a walnut separator includes an optical sensor positioned to scan harvested walnuts. A controller connected to the optical sensor processes input from the optical sensor and selectively actuates a walnut selection or ejection device to select or eject a walnut from a conveyance device. Those walnuts that include hulls are conveyed to the huller, while those walnuts that are free of the hull are diverted for conveyance to the washer and other downstream processing. Alternately the walnut separator may include a mesh, screen or grate having a selected interval between mesh, screen or grate elements that permit walnuts without hulls to pass through the screen and prohibit walnuts with hulls and therefore a larger diameter, to pass through the screen.

The present invention is also directed to a method for separating walnuts with hulls from those that do not have hulls. In a preferred embodiment of the method walnuts without hulls are diverted from a conveyance of walnuts for separate conveyance to a downstream processing step while walnuts with hulls are diverted for separate conveyance to the huller.

### BRIEF DESCRIPTION OF THE FIGURES

FIG. 1 is a representative schematic plan view of a system for processing harvested walnuts according to the present invention.

FIG. 2 is a schematic representative plan view of a walnut sorting device according to the present invention.

FIG. 3 is a schematic representative top view detail of a walnut sorting device according to the present invention.

FIG. 6 is a schematic representative plan view of a walnut sorting device according to the present invention.

FIG. 7 is a schematic representative side view detail of a walnut sorting device according to the present invention.

FIG. 8 is a schematic representative plan view of a walnut sorting device according to the present invention.

FIG. 9 is a schematic representative side view detail of a walnut sorting device according to the present invention.

FIG. 10 is a schematic flow diagram showing steps of a method for processing harvested walnuts according to the present invention.

### DETAILED DESCRIPTION

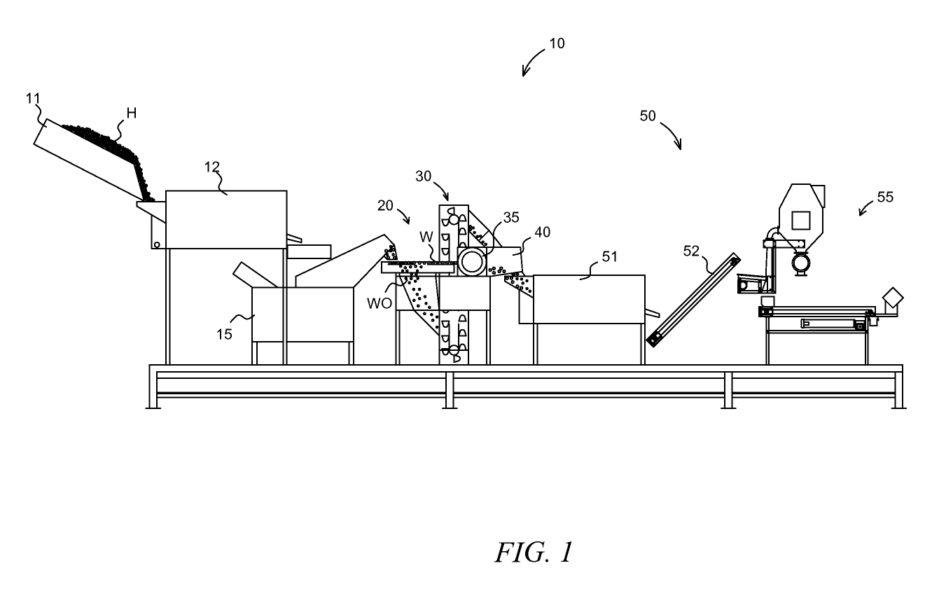

Referring to FIG. 1, system 10 for processing harvested walnuts includes, proceeding in a downstream direction, tote 11 filled with harvested walnuts H, pre-cleaner 12, float tank 15, walnut separator 20, huller by-pass system 30, huller 35, discharge 40, post-hulling processing 50 including washer 51 and post-wash processing 55 communicatively connected by conveyance device 52.

In a preferred embodiment, pre-cleaner 12 includes a rotary cage or a rod type conveyor/elevator that functions to drop out loose hulls and small rocks or dirt clods that are contained in “field run” harvested walnuts H. The action of pre-cleaner 12 also knocks some hulls off of harvested walnuts H before they advance to float tank 15. Following pre-cleaner 12, harvested walnuts H are dropped into float tank 15, which is filled with water. Walnuts being buoyant float to the top of float tank 15 and are conveyed into walnut separator 20 while rocks and dirt, which would cause damage and wear to huller 35, drop to the bottom of float tank 15 and are removed from the system.

Walnut separator 20 includes means for separating walnuts with hulls from walnuts without hulls separating and diverting those walnuts without hulls from the flow of harvested walnuts H through system 10 for processing harvested walnuts. In a preferred embodiment, walnuts with hulls are separated from walnuts without hulls on the basis of color. In an alternate embodiment, walnuts with hulls are separated from walnuts without hulls on the basis of size. Those walnuts without hulls WO are directed to huller by-pass system 30 and ultimately to a post-hulling process, in this case, washer 51. Those walnuts with hulls W are directed through huller 35 where the hulls are removed. Walnuts without hulls that were diverted around huller 35 and those walnuts that have passed through huller 35 are discharged from discharge 40 into washer 51. Washer 51 includes a rotary cage or rod conveyor. Walnuts without hulls that were diverted around huller 35 and those walnuts that have passed through huller 35 are co-mingled in washer 51 and washed to remove dirt, loose hulls and debris.

Post-wash processing 55 includes final separating and sorting to remove blank or shriveled walnuts and walnuts that still have some hull left on them. Post-wash processing 55 may also include a visual inspection, (not shown), before continuing on to a drying process, (not shown). After walnuts are dried to the desired moisture content the nuts are ready for post-drying processing, packaging and sale.

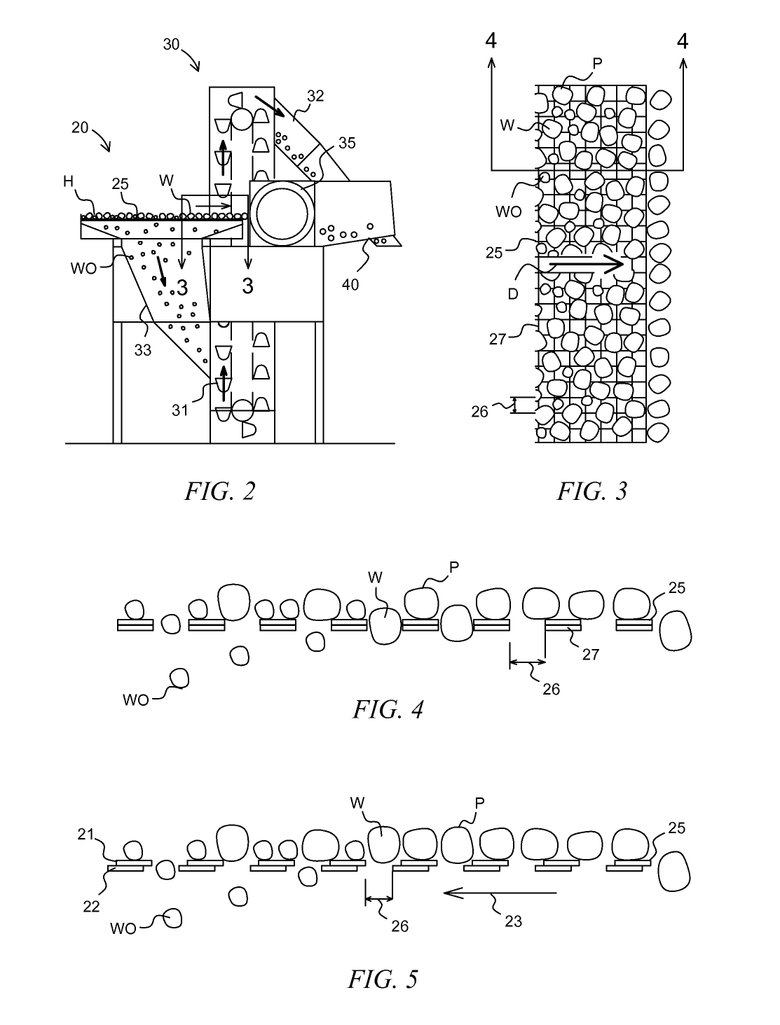

FIG. 2 is a representative side view detail showing walnut separator 20 connected to huller by-pass system 30 and huller 35, each which in turn is connected to discharge 40. Harvested walnuts H are conveyed across separator screen 25 of walnut separator 20. Harvested walnuts H include walnuts without hulls WO and walnuts with hulls W.

With additional reference to FIG. 3, those walnuts without hulls WO drop through separator screen 25 into chute 33 and are directed to bypass elevator 31 of huller by-pass system 30, (shown in FIG. 2). A perimeter P of walnuts with hulls W is too large dimensionally to permit passage of walnuts with hulls W through separator screen 25 having an interval 26 between screen the plurality of screen elements 27 and therefore walnuts with hulls W advance into huller 35.

Referring again to FIG. 2, at huller 35, hulls are peeled or scraped from the walnut shells. Following hulling, huller 35 expels hulled walnuts through discharge 40. Huller by-pass system 30 includes bypass elevator 31 and connected ducting 32 for directing walnuts without hulls WO to discharge 40.

FIGS. 4 and 5 show a feature of separator screen 25 that allows adjustment to accommodate walnuts having a range of perimeter P dimensions. As seen in FIG. 4, some walnuts with hulls W are small enough to pass through separator screen 25 having an interval 26 between screen elements 27. Referring to FIG. 5, a dimension of interval 26 may be varied by movement of lower screen plate 22 with respect to upper screen plate 21, thereby achieving a desired dimension of interval 26 so that a minimum of walnuts with hulls W pass through interval 26.

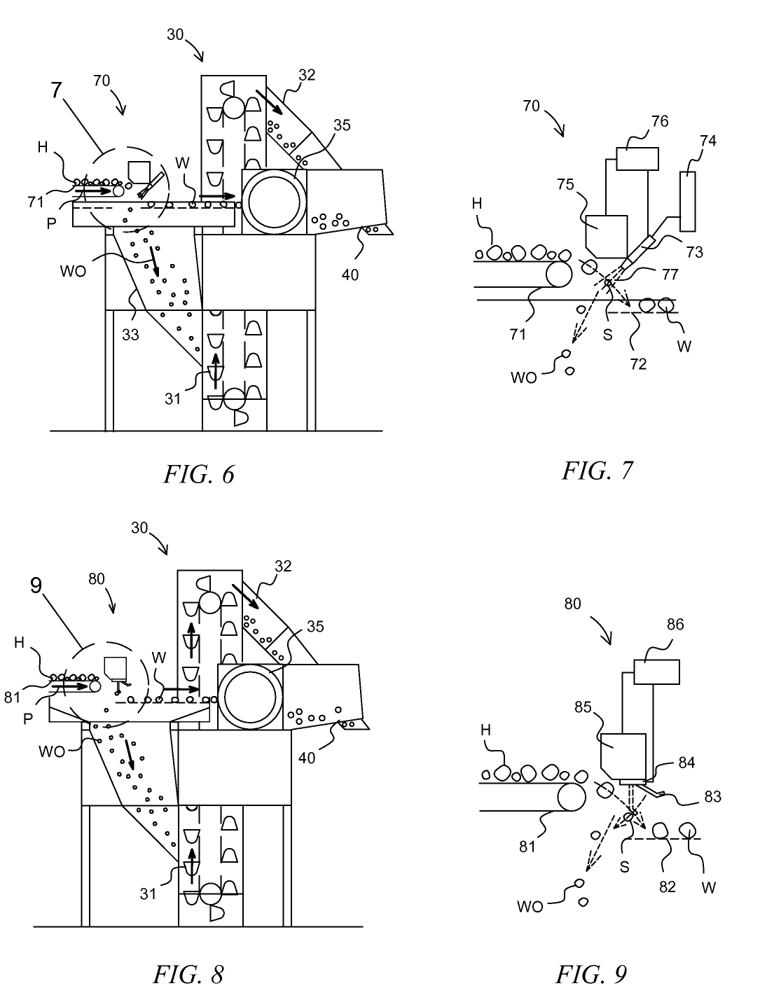

Referring to FIG. 6, a representative side view detail showing walnut separator 70 connected to huller by-pass system 30 and huller 35, each which in turn is connected to discharge 40. Harvested walnuts H are directed along process line P by conveyance 71 before walnut separator 70.

With reference to FIG. 7, walnut separator 70 includes optical sensor 75 connected to controller 76 that includes means for processing an input from optical sensor 75 and selectively actuating air jet 73, that is connected to a pressurized source of air 74, emitting jet 77. As walnuts without hulls WO are directed by past optical sensor 75, the color green is not sensed and air jet 73 is actuated to propel selected walnut S into chute 33 of huller by-pass system 30. Walnuts without hulls WO are directed through chute 33 to bypass elevator 31. As walnuts with hulls W are directed by past optical sensor 75, the color green is sensed and air jet 73 is not actuated and walnuts with hulls W are pushed by the force of conveyance 71 onto conveyor 72.

Referring again to FIG. 6, at huller 35, hulls are peeled or scraped from the walnut shells. Huller by-pass system 30 includes bypass elevator 31 and connected ducting 32 for directing walnuts without hulls WO to discharge 40. Walnuts with hulls W are directed through huller 35 and ultimately are discharged from discharge 40.

Referring to FIG. 8, a representative side view detail showing walnut separator 80 connected to huller by-pass system 30 and huller 35, each which in turn is connected to discharge 40. Harvested walnuts H are directed along process line P by conveyance 81 before walnut separator 80.

With reference to FIG. 9, walnut separator 80 includes optical sensor 85 connected to controller 86 that includes means for processing an input from optical sensor 85 and selectively actuating ejection finger 83. As walnuts without hulls WO are directed by past optical sensor 85 the color green is not sensed and ejection finger 83 is actuated by operation of actuator 84, connected to and controlled by controller 86, striking and driving selected walnut S into chute 33 of huller by-pass system 30. As walnuts with hulls W are directed by past optical sensor 85, the color green is sensed and ejection finger 83 is not actuated and walnuts with hulls W are pushed by the force of conveyance 81 onto conveyor 82.

Referring again to FIG. 8, at huller 35, hulls are peeled or scraped from the walnut shells. Huller by-pass system 30 includes bypass elevator 31 and connected ducting 32 for directing walnuts without hulls WO to discharge 40. Walnuts with hulls W are directed through huller 35 and ultimately are discharged from discharge 40.

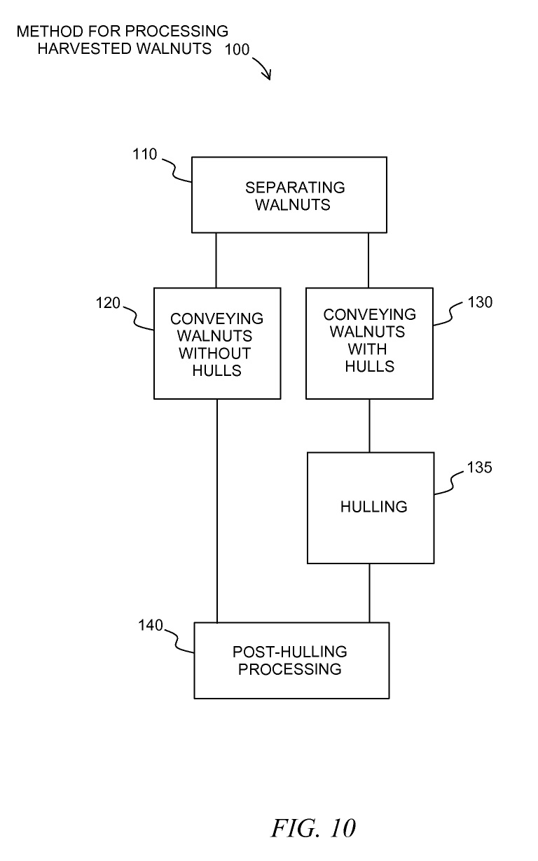

FIG. 10 is a schematic flow diagram showing steps of a METHOD FOR PROCESSING HARVESTED WALNUTS 100. At SEPARATING WALNUTS 110, harvested walnuts are processed by a walnut separator that separates walnuts without hulls from walnuts with hulls. At DIRECTING WALNUTS WITHOUT HULLS 120, walnuts without hulls are directed to POST-HULLING PROCESSING 140. At DIRECTING WALNUTS WITH HULLS 130, walnuts with hulls are directed HULLING 135 where hulls are removed, and then on to POST-HULLING PROCESSING 140.

While the invention has been described in connection with the preferred embodiment, it is not intended to limit the scope of the invention to the particular form set forth, but, on the contrary, it is intended to cover such alternatives, modifications and equivalents as may be included within the spirit and scope of the invention as defined by the appended claims.

What is claimed is:

1. A system for processing harvested walnuts comprising:
a conveyance device adapted to convey harvested walnuts along a process line;
a walnut separator connected to the first conveyance device, the walnut separator adapted to separate walnuts without hulls from walnuts with hulls;
a huller by-pass system in communication with the walnut separator, the huller by-pass system adapted to convey walnuts without hulls to a post-hulling process;
a huller in communication with the walnut separator, the huller adapted to remove hulls from the walnuts with hulls, the huller adapted to expel hulled walnuts to the post-hulling process.

2. The system for processing harvested walnuts of claim 1 wherein the walnut separator further comprises:
an optical sensor positioned to scan passing harvested walnuts on the conveyance device;
a controller connected to the optical sensor;
a walnut ejection device connected to the controller, the controller processing an input from the optical sensor and selectively actuating the walnut ejection device to eject a scanned walnut from the conveyance device.

3. The system for processing harvested walnuts of claim 2 wherein the walnut ejection device further comprises a finger adapted to strike a select walnut from the process line.

4. The system for processing harvested walnuts of claim 2 wherein the walnut ejection device further comprises an air jet adapted to propel a select walnut from the process line.

5. The system for processing harvested walnuts of claim 1 wherein the walnut separator further comprises a screen including a plurality of screen elements and an interval between adjacent screen elements, the screen configured to permit walnuts without hulls to pass between the screen elements, the screen further configured to prohibit walnuts with hulls to pass between the screen elements.

6. The system for processing harvested walnuts of claim 5 wherein the selected screen size further comprises an adjustable interval between adjacent screen elements.

7. The system for processing harvested walnuts of claim 1 further comprising a pre-cleaner in communication with the walnut separator, the pre-cleaner adapted to mechanically clean debris, loose hulls, small rocks and dirt from the harvested walnuts prior to conveyance of the harvested walnuts to the walnut separator.

8. The system for processing harvested walnuts of claim 1 further comprising a float tank in communication with the walnut separator, the float tank adapted to separate harvested walnuts by floating the harvested walnuts, from debris, loose hulls, small rocks and dirt from the harvested walnuts by gravity prior to conveyance of the harvested walnuts to the walnut separator.

9. The system for processing harvested walnuts of claim 1 further comprising a post-hulling wash in communication with the walnut separator, the post-hulling wash adapted to wash dirt, loose hulls and debris from the processed walnuts.

10. A walnut separator communicatively connectable upstream in a walnut processing stream by a conveyance device to a walnut hulling device, a huller by-pass system and thereby to a post-hulling process, the walnut separator comprising means for separating walnuts without hulls, for conveyance by the huller by-pass system to the post-hulling process, from walnuts with hulls, for conveyance to the huller.

11. The walnut separator of claim 10 wherein the means for separating walnuts comprises:
an optical sensor positioned to scan harvested walnuts on the conveyance device;
a controller connected to the optical sensor;
a walnut ejection device connected to the controller, the controller adapted to process an input from the optical sensor and selectively actuate the walnut ejection device to eject a walnut from the conveyance device.

12. The system for processing harvested walnuts of claim 11 wherein the walnut ejection device further comprises a finger adapted to strike a select walnut from the process line.

13. The system for processing harvested walnuts of claim 11 wherein the walnut ejection device further comprises an air jet adapted to propel a select walnut from the process line.

14. The system for processing harvested walnuts of claim 10 wherein the walnut separator further comprises a screen including a plurality of screen elements and an interval between adjacent screen elements, the screen configured to permit walnuts without hulls to pass between the screen elements, the screen further configured to prohibit walnuts with hulls to pass between the screen elements.

15. The system for processing harvested walnuts of claim 14 wherein the selected screen size further comprises an adjustable interval between adjacent screen elements.

16. A method of processing harvested walnuts that includes the steps of:
separating walnuts without hulls from walnuts with hulls;
conveying walnuts without hulls to a post-hulling process; and
conveying walnuts with hulls to a hulling process;
hulling the walnuts with hulls; and
conveying the hulled walnuts to the post-hulling process.

17. The method of claim 16 wherein the step of separating walnuts without hulls from walnuts with hulls includes conveying the harvested walnuts over a screen of having a selected screen size that permits walnuts without hulls to by-pass a hulling step.

18. The method of claim 16 wherein the step of separating walnuts without hulls from walnuts with hulls includes:
conveying the harvested walnuts along a conveyance device past an optical sensor positioned to scan the harvested walnuts;
selectively actuating a walnut ejection device; and
ejecting a selected walnut from the conveyance device.

19. The method of claim 18 wherein the step of selectively actuating a walnut ejection device includes actuating a walnut ejection device connected to the optical sensor through a controller, the controller processing an input from the optical sensor selectively actuating the walnut ejection device to eject a selected walnut from the conveyance device.

20. The method of claim 18 wherein the step of selectively actuating a walnut ejection device includes selectively actuating a mechanical finger to eject a selected walnut from the first conveyance device.
